(19) United States
(12) Patent Application Publication
(10) Pub. No.: US 2017/0104443 A1
(43) Pub. Date: Apr. 13, 2017

(54) SOLAR COLLECTOR FOR ARRANGEMENT IN A PASSENGER CAR

(71) Applicant: GM GLOBAL TECHNOLOGY OPERATIONS LLC, Detroit, MI (US)

(72) Inventors: Fredrik BACKMAN, Ruesselsheim (DE); Valter SKIBINSKI, Ruesselsheim (DE)

(73) Assignee: GM GLOBAL TECHNOLOGY OPERATIONS LLC, Detroit, MI (US)

(21) Appl. No.: 15/290,425

(22) Filed: Oct. 11, 2016

(30) Foreign Application Priority Data
Oct. 12, 2015 (DE) 202015007105.8

(51) Int. Cl. H02S 20/30; B60R 16/033; H02J 7/35; H02S 40/38; H02S 40/34

(52) U.S. Cl. CPC H02S 20/30; H02S 40/38; H02S 40/34; H02J 7/35; B60R 16/033

(57) ABSTRACT

A solar collector is provided for detachable arrangement on a parcel shelf of a passenger car. In this way, the solar collector can be used in the vehicle attached to the parcel shelf or outside the vehicle detached from the parcel shelf. When the solar collector is attached to the parcel shelf, electrical devices of the vehicle and external electrical devices can be operated by the solar collector. When the solar collector is disconnected from the parcel shelf, external electrical devices may still be operated by the solar collector. Accordingly, the solar collector presents itself as a mobile component which can be utilized independently of the passenger car.

### CROSS-REFERENCE TO RELATED APPLICATION

This application claims priority to German Patent Application No. 202015007105.8, filed Oct. 12, 2015, which is incorporated herein by reference in its entirety.

### TECHNICAL FIELD

The present disclosure pertains to a solar collector for arrangement on a parcel shelf of a passenger car.

### BACKGROUND

Vehicles, in particular passenger cars are known, in which a solar collector is used. Such a solar collector is connected for example with connections for operating external electrical devices or a connection for connection with an electronic system of the vehicle. In the last mentioned case, a vehicle battery can be charged for example by way of the solar collector.

From US 2009/0314556 A1 a solar collector for arrangement on a parcel shelf of a passenger car is known. This solar collector is placed on the parcel shelf. The solar collector includes connections for operating external electrical devices such as portable music playback devices, computers etc. Furthermore, the solar collector includes a connection for connecting with an electronic system of the passenger car, for example for a vehicle alarm system or a system for opening and locking the vehicle.

### SUMMARY

The present disclosure provides an improved solar collector for arrangement on a parcel shelf of a passenger car so that the same is universally employable. The present disclosure describes a solar collector for arrangement on a parcel shelf of a passenger car. Here, the solar collector includes at least one connection for operating an external electrical device. Furthermore, the solar collector is configured to be detachable connected with the parcel shelf. The solar collector can thus be used on the one hand in the vehicle, interacting with the parcel shelf, on the other hand detached from the parcel shelf, thus used outside the passenger car. When the solar collector interacts with the parcel shelf, external electrical devices can be operated by the vehicle occupant by the solar collector. When the solar collector however is disconnected from the parcel shelf, external electrical devices can also he operated in this state of the solar collector. Accordingly, the solar collector presents itself as a mobile component which can be utilized independently of the passenger car. Preferably, the solar collector includes a connection for connecting with an electronic system of the passenger car.

The external electrical devices are for example a smartphone, a DVD player, a computer or for example a mobile fan to be attached within the vehicle. The connection for connecting with the electronic system of the passenger car collects the solar collector with the electrical components of the passenger car, in particular with a control unit of the passenger car or a vehicle battery.

Practically, the solar collector is configured in such a manner that it includes a housing with a front or top side, a back or bottom side and a circumferential edge between top and bottom side. This configuration of the housing makes it possible in a simple manner with suitable means to create on the one hand the detachable connection of solar collector and parcel shelf and on the other hand to integrate the connections in the solar collector. In particular, the connections for connecting solar collector and parcel shelf are arranged in the region of the surrounding edge of the housing.

Preferably, the housing accommodates solar cells in the region of the top side. Preferably, the housing in the region of the bottom side includes a recess for accommodating at least one battery that is rechargeable by solar current generated by the solar cells. In particular, the recess serves for accommodating a plurality of rechargeable batteries. The recess is preferably closable by a lid. Accordingly, the solar collector presents itself as closed functional unit with the solar cells and the lid, which closes the receiving space for the battery or batteries.

Practically, the housing, in the region of the surrounding edge, includes the connection for connecting with the electronic system of the passenger car and/or the at least one connection for operating an external electrical device. Preferably, at least one connection is a USB connection for an electrical device and/or at least one connection an electrical connection as usual power connection for operating an external electrical device. By way of such a usual power connection, a fan can be operated for example.

Under the aspect of a simple arrangement of the solar collector with respect to the parcel shelf it is considered to be particularly advantageous when the housing is configured in such a manner that the surrounding edge is rectangular, with two parallel long edge sides and two parallel short edge sides. Thus, the housing can be easily inserted into a recessed receptacle that is correspondingly configured rectangular and in addition the solar collector, when used externally, thus when used independently of the parcel shelf, has an advantageous configuration that may be handled in an ergonomically favorable manner. In particular, the at least one connection for operating the external electrical device is arranged in the region of one of the long edge sides, preferably in the region of half the length of this edge side. The connection of the solar collector or of the housing with the parcel shelf takes place in particular in the region of the two parallel short edge sides of the housing.

Practically, the housing includes an attachment mounted in the same for connecting with the parcel shelf. The attachment or a part thereof are preferably engagement elements. Accordingly, the solar collector or the housing is inserted into the parcel shelf and connected to the parcel shelf in a form-fit manner, in particular using engagement elements.

Preferably, the attachment or engagement element includes electrical components for connecting the solar collector to electrical components of the parcel shelf, which are connected to the electronic system of the passenger car. Thus, the attachment or engagement elements not only has the function of connecting solar collector and parcel shelf but also the electrical connection of solar collector and electrical components of the parcel shelf, which are connected to the electronic system of the passenger car.

It is particularly practical when the housing on its bottom side accommodates at least one support. The support is moveable out of a position in which it is retracted into the housing into a position in which it is extended from the housing, in particular pivoted-out position. This design of the solar collector with the support makes it possible to optimally set up the solar collector when used externally and in particular when it does not interact with the parcel shelf, namely with supported housing. The solar collector can thus be favorably aligned with respect to the sun and need not lie on a surface with its bottom side.

In particular, two supports are provided which, spaced from one another, are pivotably mounted in the housing. Preferably, the respective support is extendable, so that the support length is freely variable and thus the inclination of the housing and of the solar collector is also freely adjustable. Preferably, fixtures seamlessly affix the respective support relative to the housing and/or with respect to the length of the support are provided. Accordingly it is considered to be particularly advantageous when the support is adjustable not only with respect to its angle to the housing but also the length of the support.

### BRIEF DESCRIPTION OF THE DRAWINGS

The present disclosure will hereinafter be described in conjunction with the following drawing figures, wherein like numerals denote like elements.

FIG. 1 is a rear view of a station wagon with opened tailgate and a solar collector lying on a parcel shelf of the passenger car;

FIG. 2 shows an inside view of the passenger car with solar collector lying on the parcel shelf.

FIG. 3 shows the solar collector separated from the parcel shelf and removed from the passenger car, seen on its top side, with folded-out supports;

FIG. 4 shows the solar collector according to FIG. 3 in a view of the bottom side of the solar collector;

FIG. 5 shows the solar collector according to FIGS. 3 and 4, looking at the bottom side, looking at the bottom side, with folded-in supports;

FIG. 6 shows the solar collector in a view according to FIG. 5, with lid removed;

FIG. 7 is a lateral view of a solar collector of modified design removed from a parcel shelf, standing on a base, with folded-out supports; and

FIG. 8 shows the solar collector used in FIG. 7, in the position inserted in the parcel shelf, illustrated in a sectional representation in the region of the connection of solar collector and parcel shelf.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

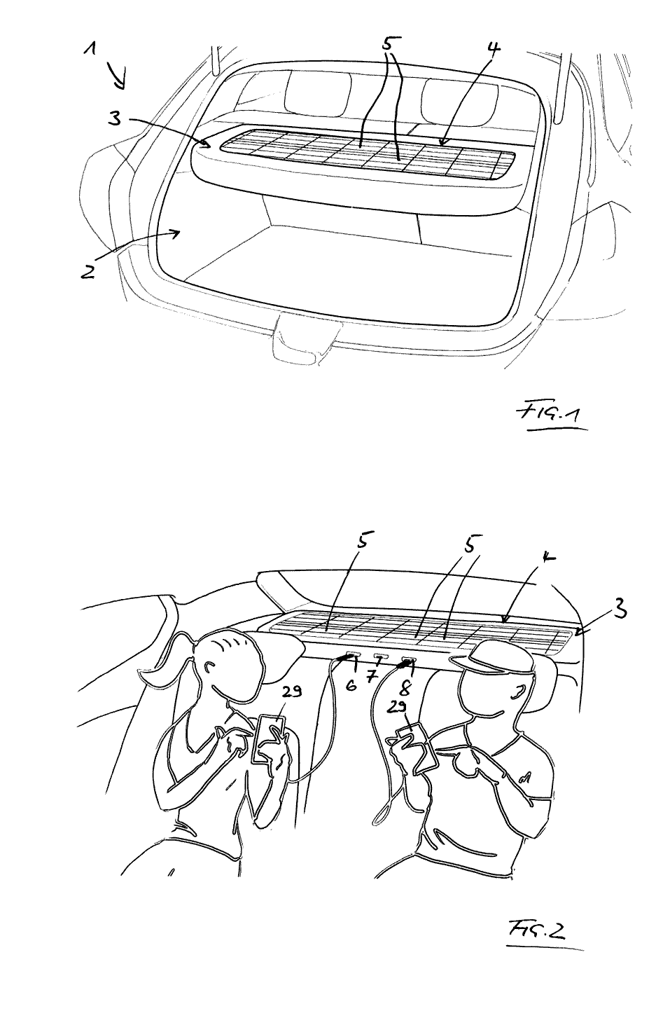

FIG. 1 illustrates a passenger car designed as a station wagon in its rear region, with opened tailgate, thus accessible load compartment 2. The same is covered at the top by a parcel shelf 3. The same is arranged horizontally and on its top side includes a recess for receiving a solar collector 4. The same receives solar cells 5 in the region of the top side. The solar collector 4, as is evident in the representation regarding FIG. 2, is provided, on its side facing the vehicle interior, with three connections 6, 7 for operating external electrical devices 29. The two connections 6 are USB connectors and the connection 7 a usual power connection, thus for connecting an external electrical device such as an electric fan, a lamp, a laptop etc.

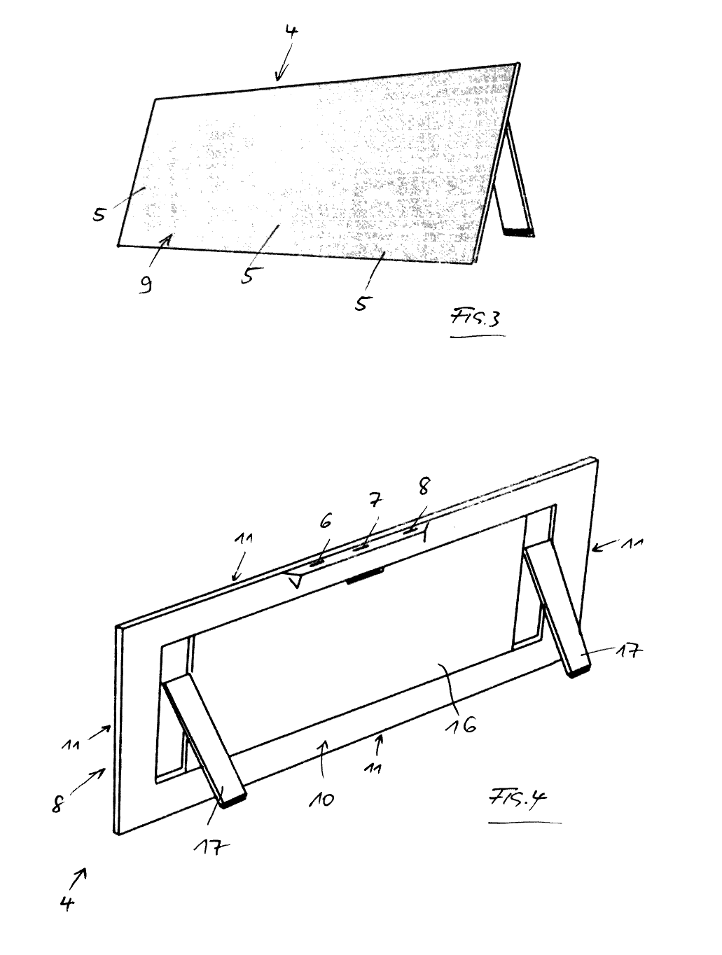

In FIGS. 3 to 6 a first exemplary embodiment of a solar collector 4 is described. The solar collector 4 includes a housing 8 with a top side 9 and a bottom side 10. Here, the specifications top side and bottom side relate to the orientation of the solar collector 4 when lying on the parcel shelf 3. In the region of the top side 9, the solar collector 4 receives the solar cells 5. Between top side 9 and bottom side 10, the housing 8 is provided with a surrounding edge 11. The same is rectangular, with two parallel long edge sides 12 and two parallel short edge sides 13. In the region of the one long edge side 12, namely the one which when the solar collector 4 lies on the parcel shelf 3, faces the vehicle interior, the housing 8 is provided with the connections 6, 7. These connections 6, 7 are arranged symmetrically, wherein the middle connection 7 is arranged in the region of half the length of this long back side 12.

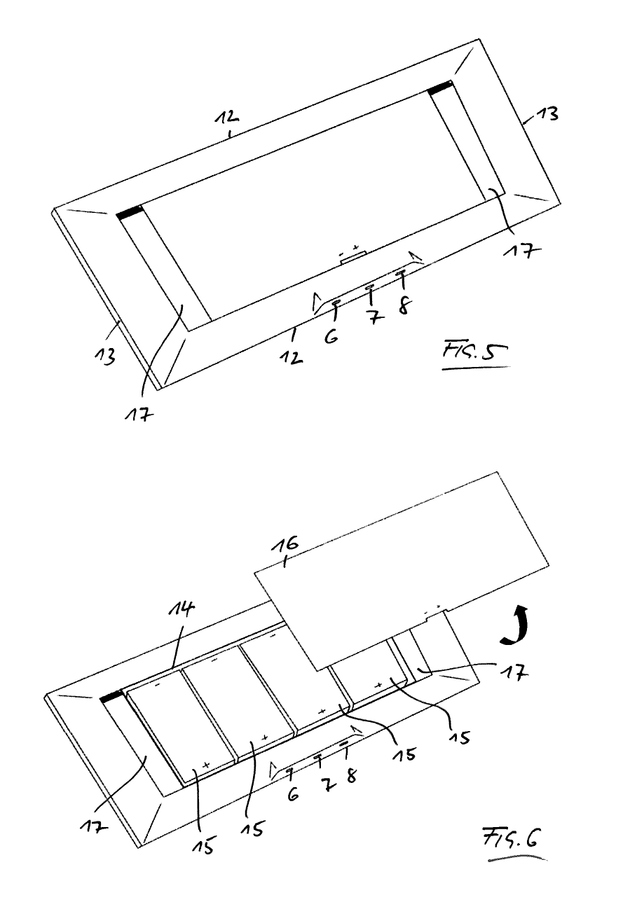

In the region of the bottom side 10, the housing 8 includes a recess 14 for receiving a plurality, in the exemplary embodiment for receiving four batteries 15 that are rechargeable by means of solar current. The recess 14 with the batteries located therein can be closed by means of a lid 16. On both sides of the lid 16 supports 17 are mounted in the housing 8. These two supports 17 can be pivoted out of the housing 8 so that the solar collector can be positioned on a base with respect to a position that is inclined to the vertical. FIGS. 3 and 4 show the supports 17 in their pivoted-out position, FIGS. 5 and 6 the supports 17 in their position in which they are pivoted into the housing 8.

In the case of this exemplary embodiment, the batteries 15 are thus recharged via the solar cells 5 and via the batteries 15 and an electronic system that is not illustrated and assigned to the solar collector 4, the external electrical devices operated,

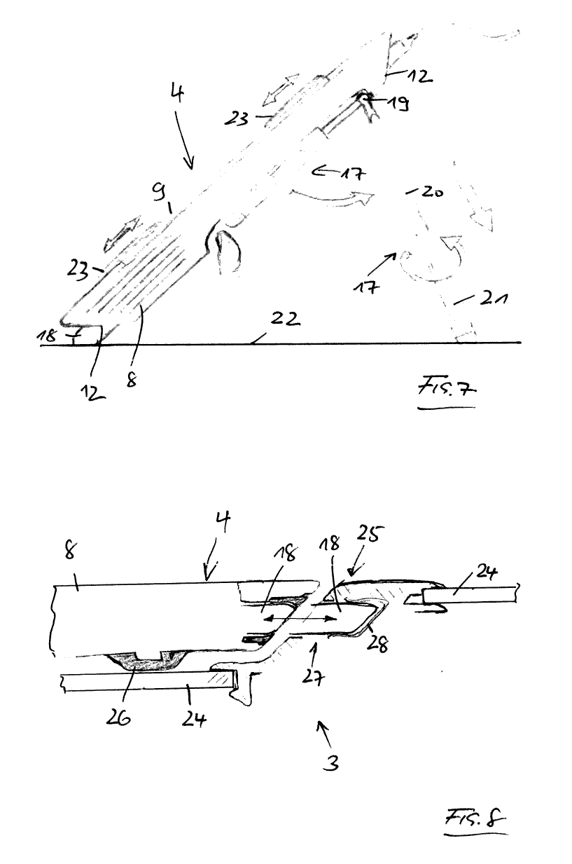

In FIGS. 7 and 8, a configuration of the solar collector 4 that is modified with respect to the exemplary embodiment according to FIGS. 3 to 6 and a modified connection of solar collector 4 and parcel shelf 3 illustrated. Parts of the two exemplary embodiments which correspond in construction or in the mode of operation are marked with the same reference numbers for the sake of simplicity,

The exemplary embodiment according to FIGS. 7 and 8 differs from that according to FIGS. 3 to 6 in that the supports 17 cannot only be pivoted out but are also extendable, furthermore in that in the housing 8 attachment 18 for connecting solar collector 4 and parcel shelf 3 are provided, wherein one or a plurality of attachments 18 not only serve for the mechanical connecting but equally for electrically contacting electrical components of the solar collector 4 and electrical components of the parcel shelf 4.

FIG. 7 illustrates one of the two supports 17 both in a position pivoted into the housing 8, with short configuration of the support 17, and also in the pivoted-out position of the support 17, with extended support 17. For extending the support 17, the same is pivoted about its pivot bearings 19. The respective support 17 includes two parts 20, 21 telescopically arranged. The part 20 in the region of an end accommodates the pivot bearing 19 and in the region of the other end is telescopically inserted into the part 21. By relatively rotating part 20 and 21, a clamping mechanism between the two parts 20, 21 may be released so that these can be moved relative to one another. By rotating back, the clamping mechanism is activated so that the two parts 20, 21 are axially fixed. The length of the support 17 is dimensioned corresponding to the desired angle of inclination of the housing 8 to a base 22.

As is further evident from the representation of FIG. 7, the housing 8 in the region of its top side 9 includes sliding elements 23 for extending an attachment 18 that is connected to the respective sliding element 23. The respective attachments 18 in the region of the long edge side 12 of the housing 8 is mounted in the same and displaceable relative to the same. Attachments 18 are thus provided on sides of the housing 8 facing away from one another for connecting the solar collector 4 with the parcel shelf 3 in the region of these long edge sides 13.

FIG. 8 shows the arrangement of solar collector 4 and parcel shelf 3, for the connecting region of a holding means 18, which additionally assumes the task of electrical connecting. Here, the parcel shelf 3 has two plate-shaped sections 24 which are arranged parallel to one another and a function section 25 connecting these sections 24. The housing 8 of the solar collector 4 on the bottom side 10 includes rubber feet 26, which support themselves on a plate-shaped section 24 assigned to these. An attachment 18 arranged in this region is illustrated on the one hand in its position retracted into the housing 8 and furthermore in its position extended from the housing 8. In the extended position, the attachment 18, which is formed as pin or plate, is inserted into a complementary receptacle 27 of the function section 25. In this receptacle 27, an electrical contact 28 (i.e., a +/− contact is inserted and held in the function section 25. The contact 28 constitutes a connection for connecting to an electronic system of the passenger car. In order to establish a conductive connection between the electrical components of the solar collector 4 and this contact 28, the attachment 18 is likewise configured as a current-conducting component that is connectable to the contact 28. The attachment 18 is connected to the electrical components of the solar collector 4.

Accordingly, when connecting parcel shelf 3 and solar collector 4 direct electrical contacting of the electrical components of the solar collector 4 with the electrical components of the passenger car takes place. This contacting may take place also by way of a plurality, in particular two attachments 18. By way of this electrical contacting a battery of the passenger car 1 can be recharged by the solar collector 4.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1-15. (canceled)

16. A solar collector for arrangement on a parcel shelf of a passenger car comprising:
at least one solar cell;
at least one rechargeable battery electrically coupled to and rechargeable by the solar cell;
a first connection configured to electrically connect an external electrical device with the battery; and
an attachment configured to detachable couple the solar collector with the parcel shelf.

17. The solar collector according to claim 16, further comprising a second connection configured to electrically connect an electronic system of the vehicle with the battery when the solar collector is coupled to the parcel shelf.

18. The solar collector according to claim 16, further comprising a plurality of first connections for operating external electrical devices, wherein at least one first connection is a USB connection for an electrical device and at least one first connection is a standard power connection for operating an external electrical device.

19. The solar collector according to claim 16, further comprising a housing having a top side supporting the solar cell, a bottom side including the attachment and a surrounding edge extending between the top side and bottom side.

20. The solar collector according to claim 19, wherein the housing in the region of the surrounding edge comprises the first connection for operating the external electrical device.

21. The solar collector according to claim 19, wherein the surrounding edge is rectangular, with two parallel long edge sides and two parallel short edge sides.

22. The solar collector according to claim 21, wherein the first connection for operating the external electrical device is arranged in the region of one of the long edge sides.

23. The solar collector according to claim 19, wherein the housing in the region of the bottom side comprises a recess for receiving the at least one rechargeable battery.

24. The solar collector according to claim 19, wherein the attachment is formed in the for connecting with an engagement element in the parcel shelf.

25. The solar collector according to claim 24, wherein at least one of the attachment or the engagement element comprises electrical components for electrical connecting of the solar collector to electrical components of the parcel shelf, which are connected to the electronic system of the passenger car.

26. The solar collector according to claim 24, wherein the housing on edge sides facing away from one another comprises the attachment for connecting with the parcel shelf.

27. The solar collector according to claim 19, further comprising at least one support received in the bottom side of the housing, wherein the support is moveable out of a position retracted in the housing into a position extended from the housing.

28. The solar collector according to claim 27, further comprising two supports spaced apart from one another and pivotably mounted in the housing.

29. The solar collector according to claim 28, further comprising a fixture seamlessly affixed to the housing, wherein each of the two supports are extendable in length.
